(19) United States
(12) Patent Application Publication
(10) Pub. No.: US 2026/0307275 A1
(43) Pub. Date: Oct. 8, 2026

(54) SUBSTRATE TRANSFER APPARATUS

(71) Applicants: KAWASAKI JUKOGYO KABUSHIKI KAISHA, Kobe-shi (JP); Kawasaki Robotics (USA), INC., Wixom, MI (US)

(72) Inventors: Haruhiko TAN, Kobe-shi (JP); Simon JEYAPALAN, Newark, CA (US); Ming ZENG, San Jose, CA (US)

(73) Assignees: KAWASAKI JUKOGYO KABUSHIKI KAISHA, Kobe-shi, Hyogo (JP); Kawasaki Robotics (USA), INC., Wixom, MI (US)

(21) Appl. No.: 19/171,924

(22) Filed: Apr. 7, 2025

(51) Int. Cl. B25J 15/00; B25J 9/00; B25J 9/02; B25J 9/04; B25J 9/16; B25J 11/00; B25J 13/08

(52) U.S. Cl. CPC B25J 15/008; B25J 9/0012; B25J 9/023; B25J 9/04; B25J 9/1674; B25J 11/0095; B25J 13/088; B25J 15/0014

(57) ABSTRACT

A substrate transfer apparatus according to one or more embodiments may include a rotator that comprises a grip pad griping a substrate and rotates the substrate, a detector that detects a positioning mark of the substrate, and a substrate transport mechanism that places the substrate on the grip pad and lifts the substrate from the grip pad. In one or more embodiments, the grip pad may have adhesiveness and grips the substrate, and have a plurality of directivity with respect to the adhesiveness.

### BACKGROUND

The disclosure relates to a substrate transfer apparatus, particularly to a substrate transfer apparatus that stably holds a substrate.

A plurality of manufacturing apparatus is used when manufacturing semiconductor substrates, liquid crystal substrates, panels, and the like (hereinafter, collectively referred to as “substrate”). A transfer apparatus is used to transport the substrate between these manufacturing devices. The substrate transfer apparatus is widely used as an industrial robot.

U.S. Patent Publication 10,875,190 (“Cutkosky”) discloses grip pads for use, augmentation, or retrofit in robotic manipulators. In Cutkosky, the grip pad identifies a dry adhesive layer with a dry adhesive wedge that interfaces with the object to be manipulated. The plurality of dry adhesive wedges are arranged in such a way that the pattern has at least two different directions for the direction of the plurality of wedges. The grip pad further identifies the sensor array under the dry adhesive layer. The data obtained from the sensor array provides an estimate of the shape and size of the contact between the grip pad and the object when the dry adhesive layer is in contact with the object.

### SUMMARY

A substrate transfer apparatus according to one or more embodiments may include a rotator that comprises a grip pad griping a substrate and rotates the substrate, a detector that detects a positioning mark of the substrate, and a substrate transport mechanism that places the substrate on the grip pad and lifts the substrate from the grip pad. In one or more embodiments, the grip pad may have adhesiveness and grips the substrate, and may have a plurality of directivity with respect to the adhesiveness. In one or more embodiments, the substrate transfer apparatus may perform positioning and eccentricity detection of the substrate based on the detected positioning mark and the edge of the substrate.

A substrate transfer apparatus according to one or more embodiments may include a base, an elevator connected to the base that is raised and lowered, and a substrate transport mechanism that is movably connected to the elevator, and transports a substrate, the substrate transport mechanism comprising a grip pad that grips substrate. In one or more embodiments, the grip pad may have a plurality of directivity with respect to adhesiveness.

A substrate transfer apparatus according to one or more embodiments may include a housing including an opening formed in an extended direction, a moving unit arranged extending inside and outside the housing through the opening, a hand including a grip pad that grips a substrate and is connected to a portion extending outside the housing, and a driver arranged in the housing and moving the moving unit in the extended direction. In one or more embodiments, the grip pad may have adhesiveness and grips the substrate, and may have a plurality of directivity with respect to the adhesiveness.

### BRIEF DESCRIPTION OF DRAWINGS

FIG. 1A is a diagram illustrating an upper surface of a substrate transfer apparatus according to one or more embodiments. FIG. 1B is a cross-sectional view of 1B-1B of FIG. 1A.

FIGS. 2A and 2B are diagrams illustrating top views of grip pads included in a substrate transfer apparatus according to one or more embodiments.

FIGS. 3A and 3B are diagrams illustrating top views of grip pads included in a substrate transfer apparatus according to one or more embodiments.

FIGS. 4A and 4B are diagrams illustrating top views of grip pads included in a substrate transfer apparatus according to one or more embodiments.

FIG. 5 is a diagram illustrating an upper surface of a substrate transfer apparatus according to one or more embodiments.

FIG. 6 is a diagram illustrating a top view of a grip pad 2 included in a substrate transfer apparatus according to one or more embodiments.

FIG. 7 is a diagram illustrating a perspective view of a substrate transfer apparatus according to one or more embodiments.

FIG. 8 is a diagram illustrating a perspective view of a substrate transfer apparatus according to one or more embodiments.

FIG. 9 is a diagram illustrating a partially cutaway perspective view of a substrate transfer apparatus according to one or more embodiments.

### DETAILED DESCRIPTION

A substrate transfer apparatus according to one or more embodiments is described in detail with reference to the drawings. In the description of the drawings, identical or similar parts may be denoted by the same or similar numerals. The description in the drawing is schematic, and the relationship between thickness and dimensions, the ratio of the length and thickness of each part, etc. are examples, and do not limit the scope of technical concept. Dimensional relationships and dimension ratios may vary between drawings. In the following description, when explaining the positional relationship of each component, "top", "bottom", "right side", "left side", etc. are appropriately used based on the orientation of the drawing to be referenced and the specific object, but these indications do not limit the scope of technical thought. Expressions such as "top", "bottom", "right side", "left side", etc. may be used even when each part is not touched. "Longitudinal direction" may mean the direction of the long side on the main surface of the member. "Width direction" may mean the direction of the short side on the main surface of the member. "Height direction" or "vertical direction" may mean a direction related to the thickness of the main surface of the member. Further, the substrate includes, for example, a semiconductor wafer and a glass wafer, and the semiconductor wafer includes a silicon wafer, a sapphire (single crystal alumina) wafer, and various other wafers and panels.

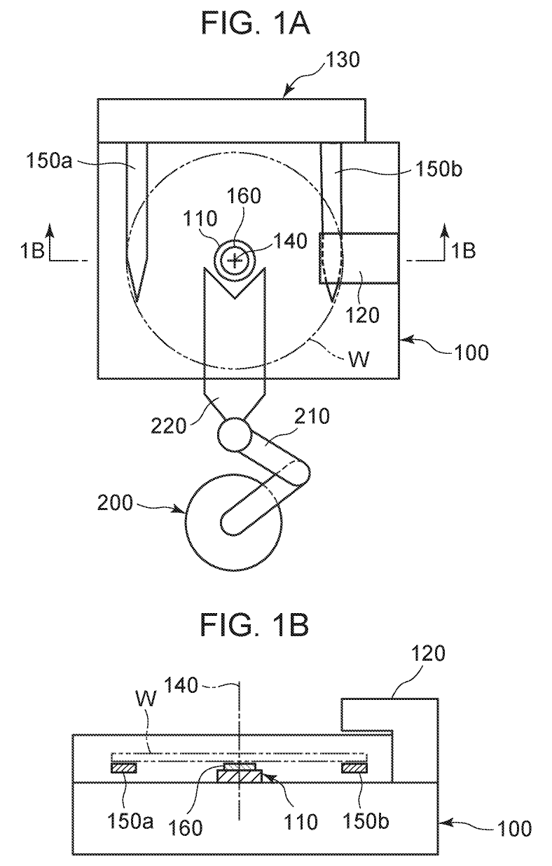

FIG. 1A is a diagram illustrating the upper surface of a substrate transfer apparatus according to one or more embodiments. In FIG. 1A, the pre-aligner device 100 is described as an example of the substrate transfer apparatus. In the semiconductor manufacturing process, when the substrate W is processed by a substrate processing apparatus such as a film formation apparatus or an etching apparatus, a positioning mark (for example, a notch, an orientation flat (orifla), etc.) formed in advance on the peripheral portion of the substrate W is used as a reference of the position. The pre-aligner device 100 is used as a device for performing the alignment described above. The pre-aligner device 100 includes the rotator 110 that grips and rotates the substrate W, and the detector 120 that detects a notch portion of the substrate W.

The rotator 110 includes the grip pad 160 that grips the substrate W that is placed on the grip pad 160. When the substrate W is placed on the grip pad 160, the substrate W is gripped on the rotator 110 by the gripping force of the grip pad 160. When the rotator 110 rotates the substrate W and aligns the substrate W, the substrate W is stably gripped on the rotator 110 by the gripping force of the grip pad 160. The substrate W placed on the grip pad 160 rotates around the rotation axis 140. The detector 120 detects a positioning mark on the substrate W placed on the rotator 110 by an imaging device (not illustrated) including an optical sensor, a CCD camera, or the like, for example. The detector 120 detects a circumference of the substrate edge to detect substrate eccentricity.

The pre-aligner device 100 includes a substrate transfer mechanism 130 that lifts the aligned substrate W from the grip pad 160 of the rotator 110. The substrate transfer mechanism 130 includes the pair of pin members 150a and 150b arranged on both sides across the rotation axis 140 of the rotator 110. The rotator 110 may include a horizontal driver that moves the pin members 150a and 150b to widen or narrow between the horizontal separation distance of the pair of pin members 150a and 150b. The substrate transfer mechanism 130 may also include an elevating driver for raising and lowering a pair of pin members 150a and 150b.

When the substrate W is placed on the rotator 110 of the pre-aligner device 100, the arm 181 of the substrate transfer apparatus 180 is driven, and the substrate W is taken out from the cassette (not shown) by the hand 182 provided at the end of the arm 181. By driving the arm 181, the substrate W is placed on the grip pad 160 of the rotator 110.

While rotating the substrate W by the rotator 110, the positioning mark on the substrate W is detected by the detector 120, and the substrate W is aligned based on the detection result.

If it is determined that the substrate W is decentered from the rotation axis 140 of the rotator 110 based on the detection result of the detector 120, the substrate W is repositioned in the correct position on the rotator 110 by the hand 182 based on the calculated de-centered amount. Alternatively, the rotator 110 may be configured to be movable, so that the eccentricity of the substrate W is adjusted by moving the rotator 110. In terms of the structure and effects of the pre-aligner device 100, the entire contents of the US Patent Publication 2011/0218663 are incorporated herein by reference.

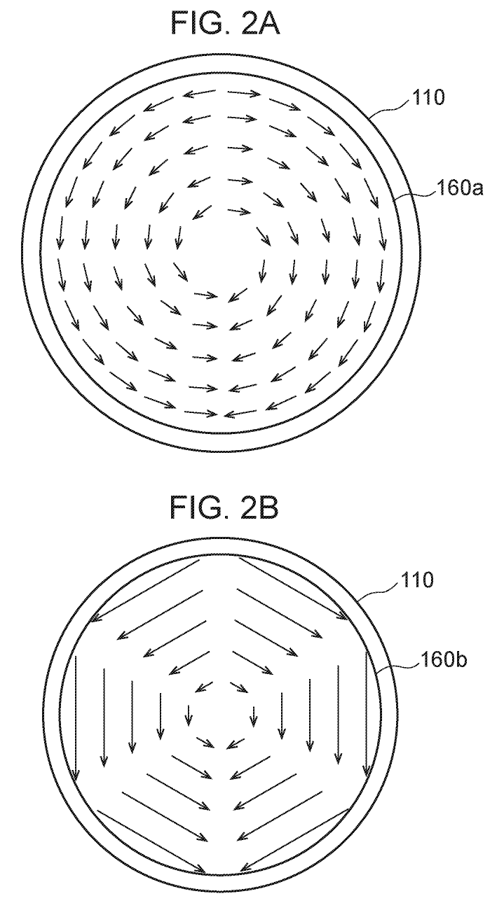

FIG. 2A is a top view illustrating the grip pad 160a included in the substrate transfer apparatus according to one or more embodiments. The grip pad 160a is provided on the top of the rotator 110 and grips the substrate W. The grip pad 160a is arranged on the rotator 110 in a portion in contact with the substrate W. The rotator 110 rotates the substrate W gripped by the rotational power.

The grip pad 160a is arranged to cover almost the entire rotator 110. The grip pad 160a has directionality with respect to adhesion. For example, when the grip pad 160a has 100% adhesion in the direction of the illustrated arrow, the grip pad 160a has an adhesion of less than 100% in the opposite direction to the direction of the illustrated arrow and vertical direction of the illustrated arrow. For example, the grip pad 160a has 70% adhesion in the opposite direction to the direction of the illustrated arrow when the direction of the illustrated arrow has 100% adhesion, and 30% adhesion in the vertical direction of the illustrated arrow. Not limited thereto, the grip pad 160a may have 10%, 20%, 30%, 40%, 50%, 60%, 70%, 80%, 90% adhesion in the opposite direction to the direction of the illustrated arrow. Further, the grip pad 160a may have 10%, 20%, 30%, 40%, 50%, 60%, 70%, 80%, 90% adhesion in the direction and vertical direction of the indicated arrow. The adhesiveness of the grip pad 160a may be defined as the ability to couple two objects together and transmit force. The adhesiveness is a force that couples two objects together, and is different from a frictional force that occurs when two objects come into contact and try to move relative to each other. The adhesiveness is a force that resists forces in various directions, and is different from a frictional force that generates a force in the opposite direction to the direction of movement of the two objects.

The grip pad 160a shown in FIG. 2A has a circular shape, and the grip pad 160a has directionality in multiple directions with respect to adhesive properties. The grip pad 160a has directionality with respect to adhesion in the direction following the circumference. Further, the grip pad 160a is divided into two semicircles, so that one semicircle has directionality related to adhesion in one direction according to the circumference, and the other semicircle has directionality related to adhesion in a direction different from the direction following the circumference. In the grip pad 160a shown in FIG. 2A, the semicircle of the grip pad 160a on the right has a directionality of adhesiveness in a clockwise direction along the circumference, and the semicircle on the left of the grip pad 160a has a directionality of adhesiveness in a counterclockwise direction along the circumference. According to the configuration, the rotating substrate W may be stably placed by the rotational power of the rotator 110. In particular, with regard to adhesion, the substrate W may be efficiently rotated by using a grip pad having different directivity according to the circumference. The grip pad 160a may have a characteristic that changes its adhesiveness in a predetermined direction of application of force.

In order to be directional with respect to adhesion, the grip pad 160a may use a technique using biomimetic technology that analyzes the excellent functions of living organisms and applies them to engineering. For example, a reversible bonding technology that may repeatedly perform bonding and separation, an adhesive technology using Van der waals force, and a dry bonding technology that exhibits adhesive power without using a sticky liquid. The material of the grip pad 160a may include polyimide fibers, carbon nanotubes, or elastomers containing silicon rubber.

FIG. 2B is a top view showing a grip pad 160b included in a substrate transfer apparatus according to one or more embodiments. The grip pad 160b shown in FIG. 2B has a circular shape, divides the circle into a plurality of sector regions, and has directionality related to adhesion in different directions for each of these sector regions. Within the region, they have the same directionality related to adhesion. The grip pad shown in FIG. 2B is divided into six sector regions, each of which has directionality with respect to adhesion in a substantially parallel direction. Not limited to the configuration, the grip pad may be divided into three, four, five, seven, eight, nine sector regions, or the like.

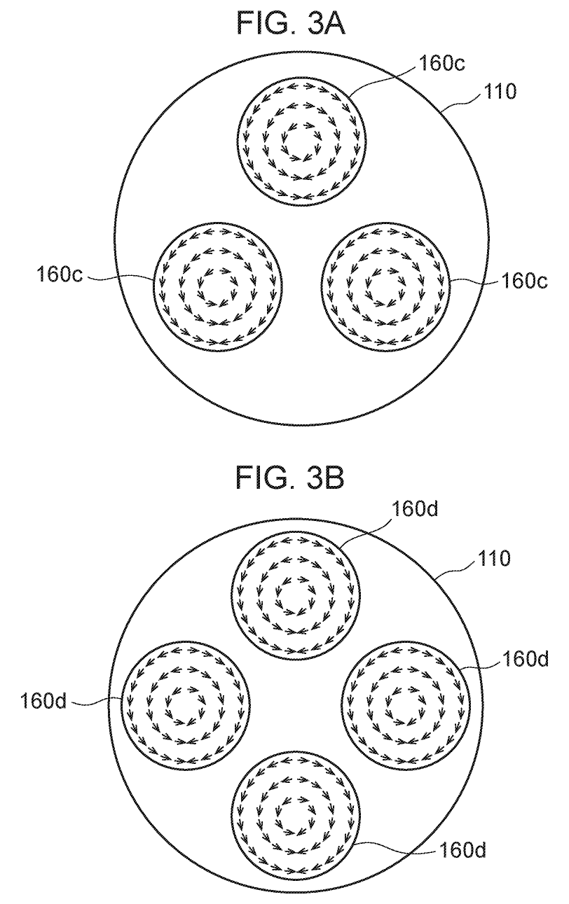

FIG. 3A is a top view showing a grip pad 160c included in the substrate transfer apparatus according to one or more embodiments. The grip pad 160c shown in FIG. 3A has a circular shape, and a plurality of grip pads 160c is placed on the rotator 110. Specifically, three grip pads 160c are arranged on the rotator 110. FIG. 3B is a top view showing a grip pad 160d included in the substrate transfer apparatus according to one or more embodiments. The grip pad 160d shown in FIG. 3B has a circular shape, and a plurality of grip pads 160d is arranged on the rotator 110. Specifically, four grip pads 160d are arranged on the rotator 110.

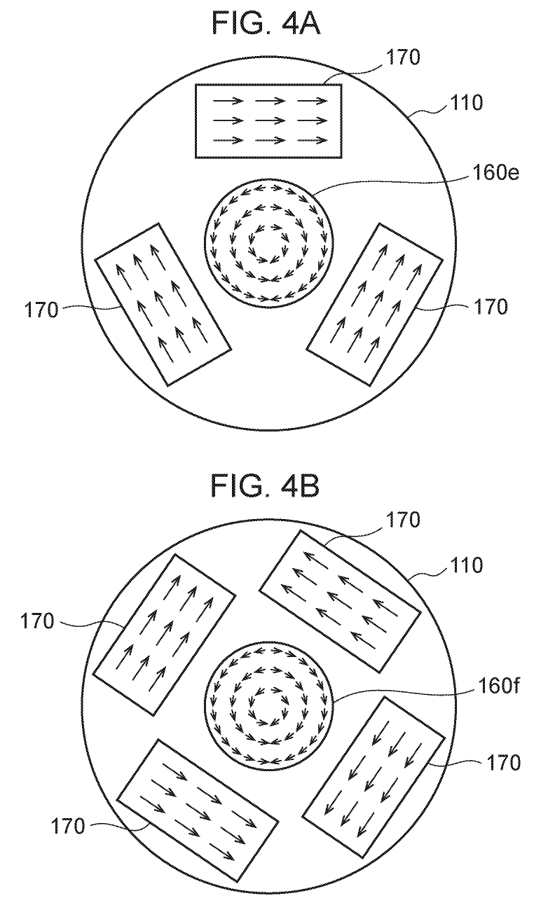

FIG. 4A is a top view illustrating the grip pad 160e included in a substrate transfer apparatus according to one or more embodiments. The grip pad 160e shown in FIG. 4A has a circular shape and is substantially centered on rotator 110. The structure of the grip pad 160e may be the same as that of the grip pads 160a and 160b. Further, a plurality of grip pads 170 is included in the peripheral portions of the surface of the rotator 110. Specifically, surface of the peripheral portions of the rotator 110 include three grip pads 170. The grip pad 170 has a rectangular shape and has directionality with respect to adhesion. For example, when the grip pad 170 has 100% adhesiveness in the direction of the illustrated arrow, it has an adhesion of less than 100% in the opposite direction of the illustrated arrow and the vertical direction of the illustrated arrow. For example, when the direction of the illustrated arrow is 100% adhesive, the grip pad 170 has 70% adhesion in the opposite direction to the direction of the illustrated arrow, and 30% adhesion in the vertical direction of the illustrated arrow. Without limiting to this configuration, the grip pad 170 may have 10%, 20%, 30%, 40%, 50%, 60%, 70%, 80%, 90% adhesiveness in the opposite direction to the direction of the indicated arrow. Further, the grip pad 170 may have adhesion of 10%, 20%, 30%, 40%, 50%, 60%, 70%, 80%, 90% in the vertical direction of the illustrated arrow. The grip pad 170 may be arranged in one direction in the directionality of the grip pad 170.

FIG. 4B is a top view showing the grip pad 160f included in a substrate transfer apparatus according to one or more embodiments. The grip pad 160f shown in FIG. 4B has a circular shape and is substantially centered on the rotator 110. The structure of the grip pad 160f may be the same as that of the grip pad 160a or 160b. Further, a plurality of grip pads 170 is included in the peripheral portions of the surface of the rotator 110. Specifically, the peripheral portions of the rotator 110 surface include four grip pads 170. The grip pad 170 has a rectangular shape and has directionality with respect to adhesion. The structure of the grip pad 170 may be the same as that of the grip pad 170 shown in FIG. 4A.

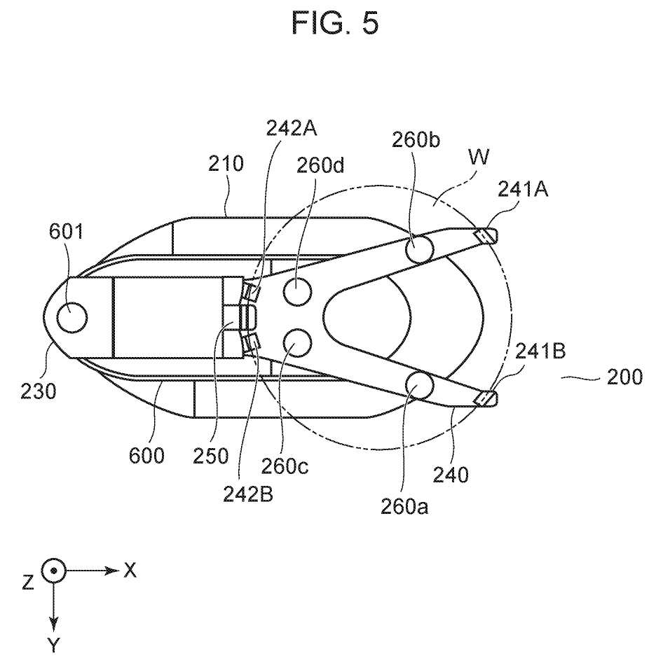

FIG. 5 is a diagram illustrating the upper surface of the substrate transfer apparatus 200 according to one or more embodiments. The substrate transfer apparatus 200 includes the base 210, an elevator, and a substrate transport mechanism for transporting the substrate. The elevator is provided to elevate and lower the link 600 and the end effector 230 freely in the vertical direction (Z direction shown). The substrate transport mechanism includes the link 600 rotatably connected to the base 210, and the end effector 230 that is rotatably connected around the rotating shaft 601 and transports the substrate W. Further, the substrate transfer apparatus 200 of FIG. 5 is illustrated but is not limited to only one link 600, and may include two, three, four, and five links 600. Further, the substrate transfer apparatus 200 may not include a link 600 and may directly connect the end effector 230 to an elevator (not shown). Further, the substrate transfer apparatus 200 may not include an elevator and may be directly connected to one or more links to the base 210. The substrate transfer apparatus 200 of FIG. 5 particularly indicates a horizontally articulated substrate transfer apparatus, but is not limited to this, and a so-called direct-acting substrate transfer apparatus that does not have a joint or a rotator may also be implemented. In the substrate transfer apparatus 200, various operations are controlled by a controller (not shown). The controller performs various operation controls including lifting and lowering operations and rotation operations of the elevator, link 600, and end effector 230.

The end effector 230 includes the hand 240 that grips the substrate W and the plunger 150 that grips and aligns the substrate in contact with the substrate W. The hand 240 includes substrate contact portions 241A, 241B, 242A, and 242B. The plunger 250 grips the substrate W. The end effector 230 acquires the substrate W from a predetermined position using the hand 240 under the control of the controller, and transports the substrate W to the predetermined position. When acquiring the substrate W stored in the FOUP (Front Opening Unified Pod) or the like, the hand 240 enters the upper or lower part of the substrate W, and when it is recognized that the hand 240 has entered to a predetermined position of the substrate W, the hand 240 stops approaching. Thereafter, a gripping operation of the substrate W is performed. At this time, the plunger 250 moves and grips the substrate W. As a method for the hand 240 to grip the substrate W, a so-called edge grip method may be used. Thereby, the end effector 230 may grip the substrate W and convey the substrate W to a predetermined position.

The hand 240 includes grip pads 260a, 260b, 260c, and 260d. The grip pads 260a, 260b, 260c, and 260d grip the substrate W when the substrate W is placed on the hand 240. When the substrate W is placed on the hand 240, the substrate W and the grip pads 260a, 260b, 260c, and 260d come into contact. With the gripping force of the grip pads 260a, 260b, 260c, and 260d, the substrate W is stably gripped on the hand 240. Thereafter, when the hand 240 transfers the substrate W to a predetermined position, the substrate W is stably transferred on the hand 240 by the gripping force of the grip pads 260a, 260b, 260c, and 260d.

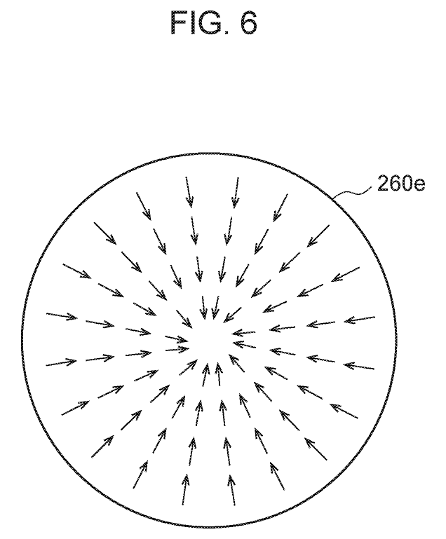

FIG. 6 is a top view showing the grip pad 260e included in the substrate transfer apparatus according to one or more embodiments. The grip pad 260e is provided on the hand 240 and grips the substrate W. The grip pad 260e is placed in contact with the substrate W on the hand 24.

The grip pad 260e has directionality with respect to adhesion. For example, when the direction of the illustrated arrow has 100% adhesion, the grip pad 260e has an adhesion of less than 100% in the opposite direction to the direction of the illustrated arrow and in the vertical direction of the illustrated arrow. For example, the grip pad 260e has 70% adhesion in the opposite direction to the direction of the illustrated arrow when the direction of the illustrated arrow has 100% adhesion, and 30% adhesion in the vertical direction of the illustrated arrow. Without limiting thereto, the grip pad 260e may have 10%, 20%, 30%, 40%, 50%, 60%, 70%, 80%, 90% adhesion in the opposite direction to the indicated arrow. Further, the grip pad 260e may have 10%, 20%, 30%, 40%, 50%, 60%, 70%, 80%, 90% adhesion in the vertical direction of the illustrated arrow.

The grip pad 260e shown in FIG. 6 has a circular shape and has directionality related to adhesion in the direction from the outer periphery of the grip pad 260 toward the center. According to this configuration, the substrate W may be stably mounted. In particular, with respect to adhesion, by using grip pads having different directivity following the circumference, the hand 240 may reliably grip the substrate W.

In order to be directional with respect to adhesion, the grip pad according to one or more embodiments may use a technique using biomimetics (biomimetic technology) that analyzes the superior functions of the organism and applies it to engineering. For example, a reversible bonding technology that may repeatedly perform bonding and separation, an adhesive technology using Van der waals force, and a dry bonding technology that exhibits adhesive power without using a sticky liquid. The material of the grip pad according to one or more embodiments may include polyimide fibers, carbon nanotubes, or elastomers containing silicon rubber.

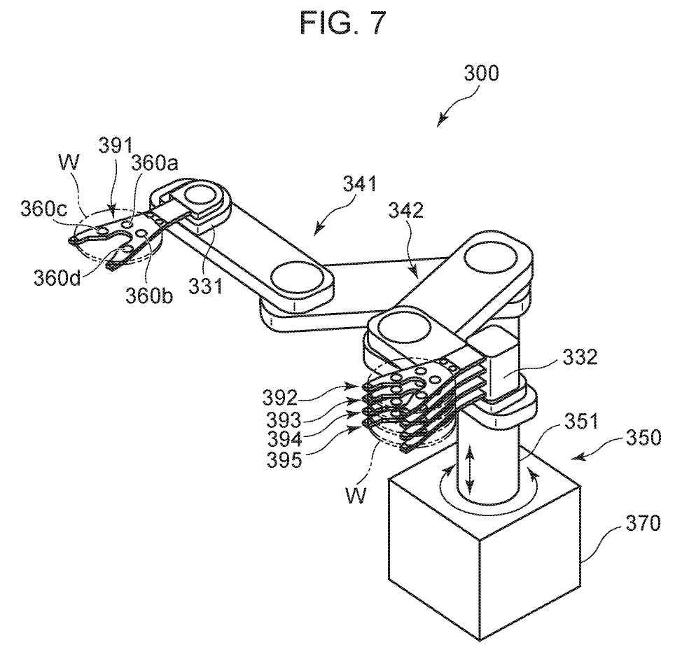

FIG. 7 is a diagram illustrating the substrate transfer apparatus 300 according to one or more embodiments. The substrate transfer apparatus 300 includes the base 370, the elevator 350, and a substrate transport mechanism. The substrate transfer apparatus 300 is a substrate transfer apparatus having a horizontal articulation. That is, the substrate transfer apparatus 300 includes the first arm 341 and the second arm 342, which are horizontally articulated robot arms. The first arm 341 and the second arm 342 each have two links. The two links are rotatably connected to each other horizontally. The first arm 341 and the second arm 342 are connected to the elevator 350. One end of the first arm 341 and the second arm 342 are rotatably connected along the horizontal direction with respect to the lifting shaft 351 of the elevator 350. The elevator 350 moves the first arm 341 and the second arm 342 up and down by moving the lifting shaft 351 along the vertical direction. The first arm 341, the second arm 342, and the elevator 350 operate by the driving force of a servo motor (not shown).

The first blade support 331 is arranged at the other end of the first arm 341. Then, the second blade support 332 is arranged at the other end of the second arm 342. The first blade support 331 is rotatable horizontally to the first arm 341. Further, the second blade support 332 is configured to be rotatable horizontally with respect to the second arm 342.

In the substrate transfer apparatus 300, the first blade support 331 supports a single blade 391. The second blade support 332 supports a plurality of blades including the blade 392, the blade 393, the blade 394, and the blade 395. The substrate transfer apparatus 300 performs an operation of transporting one substrate W by the single blade 391 of the first blade support 331, and an operation of simultaneously transporting a plurality of substrate W by a plurality of blades 392, 393, 394, and 395 of the second blade support 332.

On the blade 391, the grip pads 360a, 360b, 360c, and 360d are arranged that grips the substrate W. The grip pads 360a, 360b, 360c, and 360d may be the same as the grip pads 260e shown in FIG. 6. The grip pads 360a, 360b, 360c, and 360d may be any of the grip pads shown in FIGS. 2A, 2B, 3A, 3B, 4A and 4B. When the grip pads 360a, 360b, 360c, and 360d come into contact with the substrate W, the substrate W is gripped on the blade 391 by the gripping force of the grip pads 360a, 360b, 360c, and 360d. When moving the substrate W by the blade 391, the substrate W is stably gripped on the blade 391 by the gripping force of the grip pads 360a, 360b, 360c, and 360d. Further, the grip pads may be similarly arranged for a plurality of blades 392, 393, 394, and 395 of the second blade support 332.

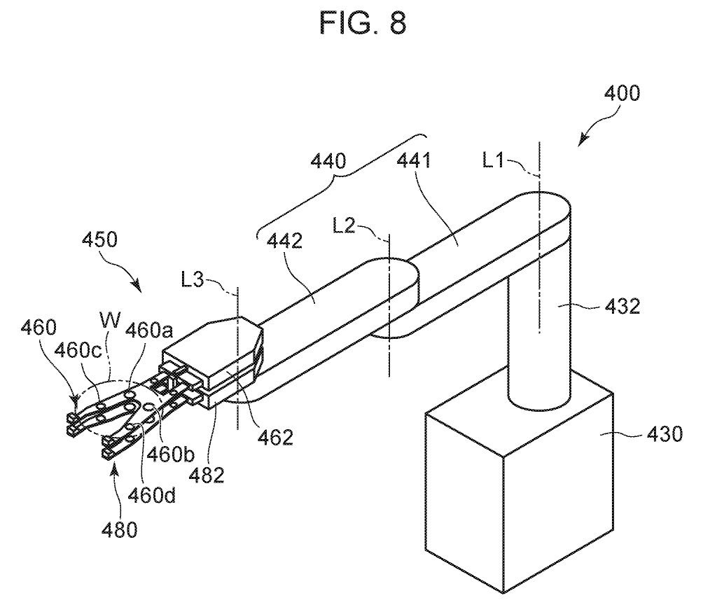

FIG. 8 is a perspective view illustrating the substrate transfer apparatus 400 according to one or more embodiments. The substrate transfer apparatus 400 is a transport robot for gripping and transporting the semiconductor substrate W in a clean room where the semiconductor is manufactured. The substrate transfer apparatus 400 is a so-called horizontally articulated three-axis robot, including the base 430, the elevator 432 provided on the upper surface of the base 430, the arm 440 attached to the upper end of the elevator 432, and the end effector 450 attached to the wrist of the arm 440. The elevator 432 is arranged in a vertical direction telescopically by an air cylinder (not shown) or the like. The elevator 432 is provided rotatable around the first rotation axis L1 extending in the vertical direction with respect to the base 430. The arm 440 includes the first link 441 and the second link 442 that include a long member extending horizontally. In the first link 441, one end of the longitudinal direction is attached to the upper end of the elevator 432. The first link 441 is integrally raised and lowered with the elevator 432 and rotates around the first rotation shaft integrally with the elevator 432. The second link 442 is rotatable mounted around the second rotation axis L2 in which one end of the longitudinal direction extends in a vertical direction to the other end in the longitudinal direction of the first link 441.

The end effector 450 is attached to the other end in the longitudinal direction (the wrist of the robot arm) of the second link 442. The end effector 450 includes the first end effector 460 and the second end effector 480 provided independently rotatable around the same third rotation axis L3 extending in the vertical direction. In one or more embodiments, the second end effector 480 is placed below the first end effector 460. The first end effector 460 and the second end effector 480 may have the same external shape as each other in planar view. The first end effector 460 and the second end effector 480 each perform an operation of gripping the substrate W independently of each other.

The first end effector 460 includes the first wrist shaft (not shown) extending vertically around the third rotation axis L3, and the first end effector 462 base formed of a hollow member connected to the upper end of the first wrist shaft. The second end effector 480 includes the second wrist shaft (not shown) which is provided outside the first wrist shaft and extends vertically around the third rotation shaft L3, the second end effector base 482 formed of a hollow member connected to the upper end of the second wrist shaft.

The first end effector 460 is driven by a drive source including a servo motor or the like. Due to the driving force generated by the drive source, the first end effector 460 rotates around the third rotation axis L3 extending in the vertical direction. Further, the second end effector 480 is driven by a drive source including a servo motor or the like. Due to the driving force generated by the drive source, the second end effector 480 rotates around the third rotation axis L3 extending in the vertical direction. The first end effector 460 and the second end effector 480 may be rotated independently.

In the hand of the first end effector 460 and the second end effector 480, the grip pad 460a, 460b, 460c, and 460d are provided for gripping the placed substrate W. The grip pads 460a, 460b, 460c, and 460d may be the same as the grip pads 260e shown in FIG. 6. The grip pads 460a, 460b, 460c, and 460d may be any of the grip pads shown in FIGS. 2A, 2B, 3A, 3B, 4A and 4B. When the grip pads 460a, 460b, 460c, and 460d come into contact with the substrate W, the substrate W is gripped on the grip pads 460a, 460b, 460c, and 460d by the gripping force of the grip pads 460a, 460b, 460c, and 460d. When the substrate W is moved by the blade 395, the substrate W is stably gripped on the blade 395 by the gripping force of the grip pads 460a, 460b, 460c, and 460d. The second end effector 480 may also have a grip pad. In general, when the double hands of a substrate transfer apparatus are used at the same time , the hands may make complex movements. This causes acceleration and deceleration in various directions in the horizontal plane. In order to use the passive hands, gripping forces in multiple directions in the horizontal plane are required. The substrate transfer apparatus 400 with double hands with a single arm according to one or more embodiments, the substrate is gripped on the grip pad, so that it is stably gripped on the substrate grip pad by the gripping force of the grip pad.

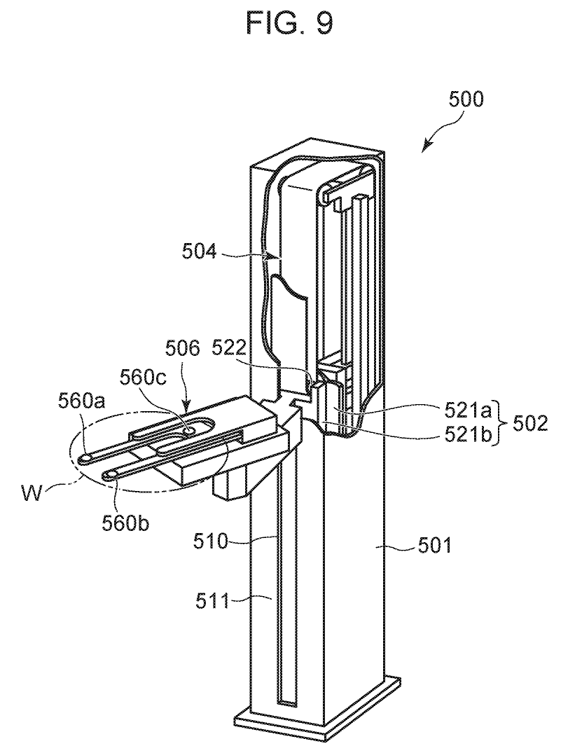

FIG. 9 is a partially cutaway perspective view illustrating the substrate transfer apparatus 500 according to one or more embodiments. The substrate transfer apparatus 500 is called a linear motion substrate transfer apparatus used for conveying a substrate in various process processing facilities such as, for example, heat treatment on the substrate, impurity introduction treatment, thin film formation treatment, lithography treatment, cleaning treatment, and flattening treatment. The substrate transfer apparatus 500 may include a dustproof mechanism for preventing particles generated by the driver inside from flowing out. The substrate transfer apparatus 500 includes the housing 501, the moving unit 502, the driver 503, the seal belt 504, and the hand 506.

The housing 501 includes a box shaped body. The housing 501 includes the opening 510 extending in a predetermined direction and having a first end and a second end in the extension direction. The opening 510 has a rectangular shape which extends in a straight line perpendicular to the front wall 511 of the housing 501. The moving unit 502 extends inside and outside the housing 501 through the opening 510. Then, the hand 506 is provided in a portion extending outside the housing 501.

In the substrate transfer apparatus 500 according to one or more embodiments, the moving unit 502 includes the internal material 521a placed inside the opening 510 of the housing 501, and the external material 521b placed outside the opening 510 of the housing 501. The hand 506 is provided in the external material 521b. The roller 522 is a cylindrical body extending in the width direction of the opening 510 and is placed in the vicinity of the opening 510 of the internal material 521a. The roller 522 is rotatable at both ends with respect to the moving unit 502, and is mounted so that it rotates around a rotational shaft extending in the width direction of the opening 510. The roller 522 moves up and down due to the seal belt 4, and the moving unit 502 moves up and down accordingly. Thereby, the hand 506 moves up and down.

The hand 506 has a shape in which the end is divided into two. The two divided ends include grip pads 560a and 560b. Further, the base portion of the hand 506 includes the grip pad 560c. These grip pads 560a, 560b, and 506c are placed on the upper surface of the hand 506. When the grip pad 160 comes into contact with the substrate W, the substrate W is gripped on the rotator 110 by the gripping force of the grip pad 160. The grip pads 460a, 460b, 460c, and 460d may be the same as the grip pads 260e shown in FIG. 6. The grip pads 560a, 560b, and 560c may be any of the grip pads shown in FIGS. 2A, 2B, 3A, 3B, 4A and 4B. When the grip pads 560a, 560b, and 560c come into contact with the substrate W, the substrate W is gripped on the grip pads 560a, 560b, and 560c due to the gripping force of the grip pads 560a, 560b, and 560c. When the substrate W is moved by the hand 506, the substrate W is stably gripped on the hand 506 by the gripping force of the grip pads 560a, 560b, and 560c.

In general, a linear motion substrate transfer apparatus may move the hand forward and backward at a higher speed than a link-type apparatus. Therefore, since acceleration and deceleration are applied in the forward and backward directions, a strong gripping force in the forward and backward directions is required to apply a passive hand. A linear motion substrate transfer apparatus according to one or more embodiments, the substrate is gripped on the grip pad, so that it is stably gripped on the substrate grip pad by the gripping force of the grip pad.

One or more embodiments described above herein may be combined with each other as far as practicable within the scope of the intended embodiment. One or more embodiments are exemplary in all respects and should not be considered limiting. The illustrated and described embodiments may be extended to include other embodiments in addition to those specifically delivered, without departing from the technical scope. The technical scope should be determined not only by the foregoing description, but also in the light of the specification containing equivalents. Thus, all configurations, including the technical and equal ranges, are intended to be included in the technical range.

1. A substrate transfer apparatus comprising:
a rotator that comprises a grip pad griping a substrate and rotates the substrate;
a detector that detects a positioning mark of the substrate; and an edge of the substrate and
a substrate transport mechanism that places the substrate on the grip pad and lifts the substrate from the grip pad, wherein
the grip pad has adhesiveness and grips the substrate, and has a plurality of directivity with respect to the adhesiveness,
the substrate transfer apparatus performs positioning and eccentricity detection of the substrate based on the detected positioning mark and the edge of the substrate.

2. The substrate transfer apparatus according to claim 1, wherein
the grip pad has a directionality of adhesion in a direction following a circumference of the grip pad.

3. The substrate transfer apparatus according to claim 2, wherein
the grip pad has a forward directionality of adhesion higher than an opposite directionality of adhesion.

4. The substrate transfer apparatus according to claim 1, wherein
the grip pad has a circular shape and comprises a first semicircle region and a second semicircle region into which divide the circular shape of the grip pad, the first semicircle region has a directionality of adhesion in a first direction along a circumference of the grip pad, and the second semicircle region has a directionality of adhesion in a second direction along the circumference that is different from the first direction.

5. The substrate transfer apparatus according to claim 4, wherein
the grip pad has a forward directionality of adhesion higher than an opposite directionality of adhesion.

6. The substrate transfer apparatus according to claim 1, wherein
the grip pad has a circular shape and comprises at least three sector regions into which divide the circular shape of the grip pad, and the at least three sector regions have directionality of adhesion in at least two different directions, and each of the sector regions has directionality of adhesion in a same direction within the sector regions.

7. The substrate transfer apparatus according to claim 1, wherein
the grip pad comprises at least one selected from an elastomer containing a polyimide fiber, carbon nanotubes, and silicon rubber.

8. The substrate transfer apparatus according to claim 1, wherein
the rotator comprises a plurality of grip pads.

9. The substrate transfer apparatus according to claim 1, wherein
the adhesiveness of the grip pad changes in predetermined direction of application of force.

10. A substrate transfer apparatus, comprising:
a base;
an elevator connected to the base that is raised and lowered; and
a substrate transport mechanism that is movably connected to the elevator, and transports a substrate, the substrate transport mechanism comprising a grip pad that grips substrate, wherein
the grip pad has a plurality of directivity with respect to adhesiveness.

11. The substrate transfer apparatus according to claim 10, wherein
the substrate transport mechanism comprises:
a first arm connected to the elevator;
a first blade support connected to the first arm and supporting a first blade comprising a grip pad;
a second arm connected to the elevator; and
a second blade support connected to the second arm and supporting a second blade comprising a grip pad and a third blade comprising a grip pad, wherein
the second blade support transports the substrate independently of the first blade support.

12. The substrate transfer apparatus according to claim 10, wherein the substrate transport mechanism comprises:
an arm connected to the elevator;
a first end effector connected to the arm and comprising a grip pad; and
a second end effector connected to the arm and comprising a grip pad, wherein
the second end effector transports a substrate independently of the first end effector.

13. The substrate transfer apparatus according to claim 11, wherein
the grip pad has a circular shape.

14. The substrate transfer apparatus according to claim 13, wherein
the grip pad has directionality of adhesion in a direction following a circumference of the grip pad.

15. The substrate transfer apparatus according to claim 14, wherein
the grip pad has a forward directionality of adhesion higher than an opposite directionality of adhesion.

16. The substrate transfer apparatus according to claim 13, wherein
the grip pad comprises a first semicircle region and a second semicircle region that divide the circular shape of the grip pad into two semicircles, the first semicircle region has a directionality of adhesion in a first direction along a circumference of the grip pad, and the second semicircle region has a directionality of adhesion in a second direction that is different from the first direction along the circumference.

17. A substrate transfer apparatus comprising:
a housing comprising an opening formed in an extended direction;
a moving unit arranged extending inside and outside the housing through the opening;
a hand comprising a grip pad that grips a substrate and is connected to a portion extending outside the housing; and
a driver arranged in the housing and moving the moving unit in the extended direction, wherein
the grip pad has adhesiveness and grips the substrate, and has a plurality of directivity with respect to the adhesiveness.
